(19) United States
(12) Patent Application Publication
(10) Pub. No.: US 2015/0242219 A1
(43) Pub. Date: Aug. 27, 2015

(54) COMPUTER SYSTEM AND CONTROL METHOD

(71) Applicant: Wistron Corp., New Taipei City (TW)

(72) Inventor: Che Ming LIU, New Taipei City (TW)

(73) Assignee: Wistron Corp., New Taipei City (TW)

(21) Appl. No.: 14/284,313

(22) Filed: May 21, 2014

(30) Foreign Application Priority Data
Feb. 26, 2014 (TW) 103106412

(51) Int. Cl. G06F 9/44

(52) U.S. Cl. CPC G06F 9/4406

(57) ABSTRACT

A control method to re-initiate a computer system is provided. The computer system includes a control unit and a storage unit. The storage unit includes a first storage block and a second storage block to store a first initiating code and a second initiating code. The first storage block is different from the second storage block. The control method includes determining by the control unit whether the computer system can be initiated normally. When the computer system can be initiated normally, it enters into a normal operation mode. When the computer system cannot be initiated normally, it enters into an emergency back-up mode, and then the control unit reads the second initiating code on the second storage block to re-initiate the computer system.

### CROSS REFERENCE TO RELATED APPLICATIONS

This Application claims priority of Taiwan Patent Application No. 103106412, filed on Feb. 26, 2014, the entirety of which is incorporated by reference herein.

### BACKGROUND OF THE INVENTION

1. Field of the Invention

The present invention relates to a computer system and its control method for resetting, and in particular to the control method for controlling the recovery procedure and the Basic Input/Output System (BIOS) by the control unit.

2. Description of the Related Art

Generally, when the user turns on the power of the computer system, the BIOS will implement many procedures to perform the booting procedure, then the computer system loads and implements the Operating System (OS). Under the structure of the Unified Extensible Firmware Interface (UEFI), the variables replace part of the functions of the conventional BIOS to store important data for setting BIOS. The variables are stored on the storage unit of the computer system, and therefore the variables and data of the storage unit are frequently read and written.

However, if the variables and data of the storing device are damaged or incomplete, the computer system will not boot properly. In addition, due to the frequent reading and writing of the storage unit, once an error occurs (such as writing the wrong data or damaging the normal-boot program code with a power interruption while writing), the user will not be able to boot the computer system. It takes much effort to deliver the computer system to the original maintenance center. Therefore, a computer system and control method of rebooting and displaying indication information about rebooting are needed, so that the user could boot the computer system by themselves with the indication information.

### BRIEF SUMMARY OF THE INVENTION

The present invention provides a control method to re-initiate a computer system. The computer system includes a control unit and a storage unit. The storage unit includes a first storage block and a second storage block to store a first initiating code and a second initiating code. The first storage block is different from the second storage block. The control method includes determining, by the control unit, whether the computer system can be initiated normally. When the computer system can be initiated normally, it enters into a normal operation mode. When the computer system cannot be initiated normally, it enters into an emergency back-up mode, and then the control unit reads the second initiating code on the second storage block to re-initiate the computer system.

The present invention provides a computer system including a storage unit and a control unit. The storage unit includes a first storage block and a second storage block that respectively store a first initiating code and a second initiating code. The first storage block is different from the second storage block. The control unit is utilized to determine whether the computer system is initiated normally or not. The computer system enters a normal operation mode when the control unit determines that the computer system is initiated normally, and the computer system enters an emergency back-up mode and the control unit reads the second initiating code of the second storage block for re-initiating the computer system when the control unit determines that the computer system is not initiated normally.

### BRIEF DESCRIPTION OF THE DRAWINGS

The present invention can be more fully understood by reading the subsequent detailed description and examples with references made to the accompanying drawings, wherein:

FIG. 1 is a schematic diagram of the computer system according to an embodiment of the invention.

FIG. 2 is a schematic diagram of the storage unit according to an embodiment of the invention.

FIG. 3 is a schematic diagram of the control method for rebooting the computer system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

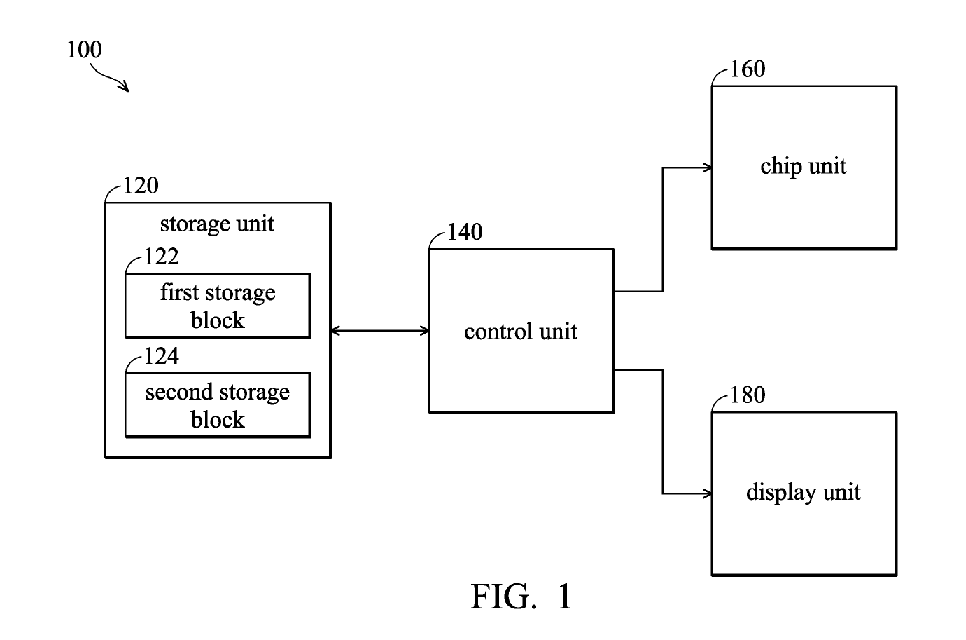

FIG. 1 is a schematic diagram of the computer system 100 according to an embodiment of the invention. For example, the computer system 100 can be a laptop computer, an e-book, a cell-phone or another mobile device with a touch screen. As shown in FIG. 1, the computer system 100 includes a storage unit 120, a control unit 140, a chip unit 160 and a display unit 180. It should be noted that, in the embodiments of the present invention, each unit could be composed of hardware components including a chip, a controller, a storage device and/or other necessary circuits. For example, the storage unit 120 includes one or a plurality of a random access memory (RAM), a read-only memory (ROM), a flash memory, a hard disk, a soft disk, a magnetic memory, a compact disc (CD) and a digital video disk (DVD). The control unit 140 includes a digital signal processor (DSP), a microcontroller (MCU), a central-processing unit (CPU) or a plurality of parallel processors relating the parallel processing environment to implement the OS, firmware, driver and the application programs. The display unit 180 includes a liquid crystal panel and various kinds of touch panels. The chip unit 160 includes a chip set, such as a south bridge chip, a north bridge chip or a combination of the two.

In one embodiment, the storage unit 120 includes a first storage block 122 and a second storage block 124, which is different from the first storage block 112. The first storage block 122 and the second storage block 124 store a first initiating code and a second initiating code respectively. The first initiating code and the second initiating code are booting programs to boot the computer system 100. In another embodiment, the first initiating code and the second initiating code include important data such as BIOS and the setting of BIOS to drive the display card and the input/output device(s) of the computer system 110 and to read data from other storage devices for recovering the damaged BIOS. Specifically, BIOS code is usually stored in the storage unit 120. When the computer system provides the system power needed by the control unit 140, the control unit 140 accesses and executes the BIOS code of the storage unit 120 to implement the booting procedure of the computer system 100.

In addition, the control unit 140 is utilized to determine whether the computer system 100 is initiated normally or not. In one embodiment, when the control unit 140 determines that the computer system 100 can be normally initiated, the computer system 100 enters a normal operation mode. When the control unit 140 determines that the computer system 100 cannot be normally initiated, the computer system 100 enters an emergency back-up mode. When the computer system 100 enters the emergency back-up mode, the control unit 140 reads the second initiating code stored at the second storage block 124 to re-initiate the computer system 100. Specifically, the second initiating code includes indication information about re-initiating the computer system 100, and the control unit 140 displays the indication information on the display unit 180 of the computer system 100. For example, the indication information includes the methods of downloading BIOS or firmware from other computer systems, so the users could solve the problem of not being able to boot the computer system 100 by downloading BIOS or firmware. In addition, the indication information also includes the contact information of the maintenance center, so the users can easily contact the maintenance center when they cannot boot the computer system 100 and decide to deliver and repair the computer system 100 by the maintenance center.

Therefore, when the computer system 100 cannot be booted properly due to damage or incomplete variable and data (the first initiating code) of the control unit 140 or due to an improper operation in the process of reading or writing the storage unit 120, the control unit 140 of the above control method could be utilized to read the second initiating code and re-initiate the computer system 100. Because the display unit 180 would display the indication information about re-initiating the computer system 100 when the control unit 140 reads the second initiating code, the user could perform simple repairs according to the indication information. If the computer system still cannot be re-initiated, the maintenance center could be contacted later. Therefore, the human resources, time, and cost of the user and the maintenance center are reduced.

In one embodiment, when the computer system 100 enters the normal operation mode, the second initiating code of the second storage block 124 cannot be read or written. In other words, the control unit 140 or other processing units are forbidden to read and/or write the second initiating code of the second storage block 124. Therefore, the second initiating code could be protected by being stored in the second storage block 124 completely and correctly. Once the computer system enters the emergency back-up mode, the control unit 140 could precisely read the second initiating code needed for rebooting. Specifically, when the computer system 100 enters the emergency back-up mode, the control unit 140 drives the chipset unit 160 to reset the computer system 100, then the control unit 140 reads the second initiating code of the second storage block, and re-initiates the computer system 100. For example, the control unit 140 sets the first pin connecting the chip unit 160 as the specific level, so the computer system 100 enters the emergency back-up mode. In addition, the control unit 140 sets the second pin connecting the chip unit 160 as another specific level, so the computer system 100 would reset.

It should be noted that when the computer system 100 enters the emergency back-up mode, the control unit 140 would not update or repair the first initiating code at the first storage block 122, but directly read the second initiating code at the second storage block 124. Compared to updating or repairing the first initiating code at the first storage block 122, directly reading the second initiating code at the second storage block 124 provides another solution which is faster, more convenient and more cost-saving.

In one embodiment, when the control unit 140 does not receive the first initiating code from the storage unit 120 within a pre-determined time, the control unit 140 determines that the computer system 100 cannot be normally initiated and the emergency back-up mode is entered. In another embodiment, when the control unit 140 receives the first initiating code from the storage unit 120 within a pre-determined time but does not receive the OS code from the storage unit 120 for initiating the OS, the control unit 140 determines that it cannot normally initiate the computer system 100 as per normal. For example, the OS code is stored at the first storage block 122. In another embodiment, the OS code succeeds to the first initiating code, and both are stored in the first storage block 122.

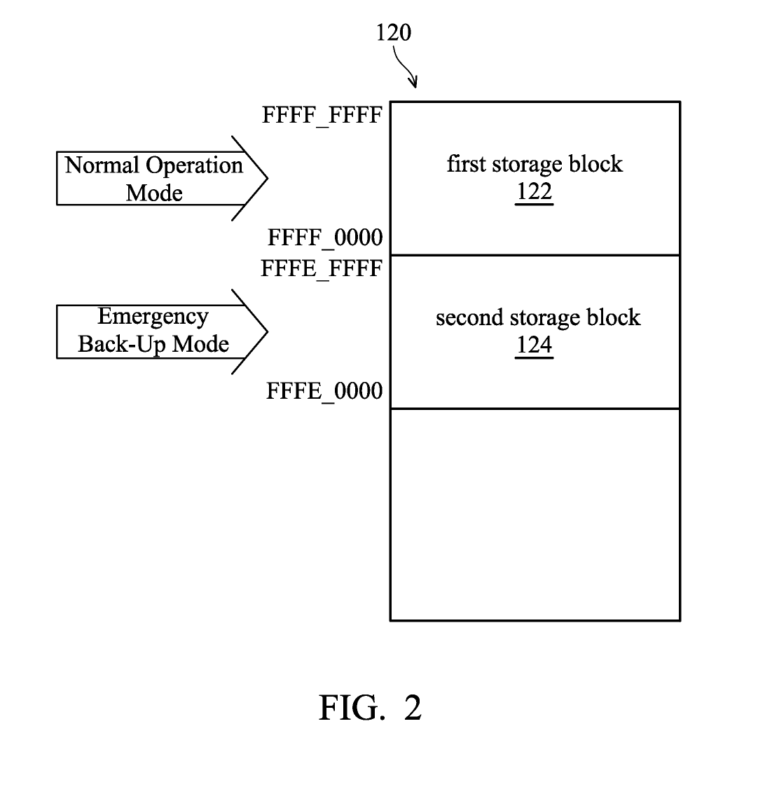

FIG. 2 is a schematic diagram of the storage unit 120 according to an embodiment of the invention. In this embodiment, when the computer system 100 enters the normal operation mode, the control unit 140 would read the first initiating code of the first storage block 122. When the computer system 100 enters the emergency back-up mode, the control unit 140 would read the second initiating code of the second storage block 124. For example, as shown in FIG. 2, the storing address of the first initiating code is FFFF_FFFF˜FFFF_{—}0000, and the storing address of the second initiating code is FFFE_FFFF˜FFFE_{—}0000. In this embodiment, the storing address of FFFE_FFFF˜FFFE_{—}0000 succeeds to the storing address of FFFF_FFFF˜FFFF_{—}0000. In other words, the two storing addresses are continuous. In addition, the computer system 100 further includes a processing unit for reading or writing the first initiating code or the second initiating code. When the computer system 100 enters the emergency back-up mode, then the storing address of the storage unit 120 for the processing unit to read would change from FFFF_FFFF˜FFFF_{—}0000 to FFFE_FFFF˜FFFE_{—}0000. In other words, the processing unit reads the second initiating code rather than the first initiating code. Afterwards, the processing unit transmits the second initiating code that has been read to the control unit 140 for re-initiating the computer system 100. In this embodiment, the storing address of FFFE_FFFF˜FFFE_{—}0000 does not succeed to the storing address of FFFF_FFFF˜FFFF_{—}0000. In other words, these two storing addresses are not continuous.

In another embodiment, the present invention provides a computer program product utilized by a machine to re-initiate the computer system 100. The computer program product includes a first code, a second code, a third code and a fourth code. The first code is utilized to determine whether the computer system 100 is initiated normally or not. When the computer system 100 can be normally initiated, the computer system 100 enters a normal mode. When the computer system 100 cannot be initiated normally, the computer system 100 enters an emergency back-up mode. Afterwards, the second code is utilized for reading the first initiating code of the first storage block 122 of the storage unit 120 of the computer system 100 when the computer system 100 enters a normal mode. The third code is utilized for reading the second initiating code of the second storage block 124 of the storage unit 120 of the computer system 100 for re-initiating the computer system 100 when the computer system 100 enters the emergency back-up mode. It should be noted that the second initiating code includes the indication information about re-initiating the computer system 100, and the first storage block is different from the second storage block. Afterwards, the fourth code is utilized to display the indication information on the display unit 180 of the computer system 100.

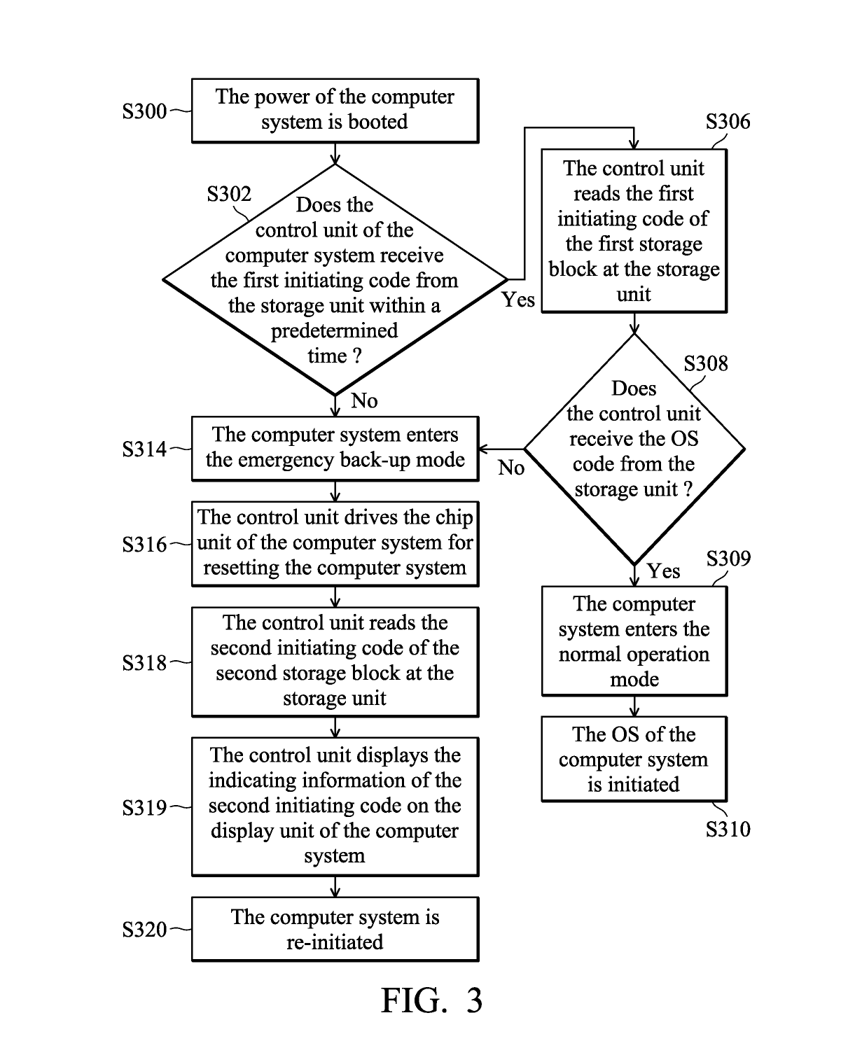

FIG. 3 is a schematic diagram of the control method for rebooting the computer system 100 according to an embodiment of the invention. First, in step S300, the power of the computer system 100 is booted. Afterwards, in step S302, whether the control unit 140 of the computer system 100 receives the first initiating code from the storage unit 120 within a predetermined time is determined. If the control unit 140 receives the first initiating code from the storage unit 120 within a predetermined time, step S306 is performed. If the control unit 140 does not receive the first initiating code from the storage unit 120 within a predetermined time, step S314 is performed. In step S306, the control unit 140 reads the first initiating code of the first storage block 122 at the storage unit 120. Afterwards, in step S308, whether the control unit 140 receives the OS code from the storage unit 120 is determined. If the control unit 140 receives the OS code from the storage unit 120, step S309 is performed so that the computer system 100 enters the normal operation mode. Afterwards, in step S310, the control unit 140 initiates the OS of the computer system 100. If the control unit 140 does not receive the OS code from the storage unit 120, step S314 is performed so that the computer system 100 enters the emergency back-up mode. Afterwards, in step S316, the control unit 140 drives the chip unit 160 of the computer system 100 for resetting the computer system 100. Afterwards, in step S318, the control unit 140 reads the second initiating code of the second storage block 124 at the storage unit 120. Afterwards, in step S319, the control unit 140 displays the indication information of the second initiating code on the display unit 180 of the computer system 100. Finally, in step S320, the control unit 140 re-initiates the computer system 100. The above control method for re-initiating the computer system 100 is illustrated as before, and is not repeated again.

Certain types or certain portions of the method of the present invention could take the form of computer code. The code could be stored in physical media such as soft disks, optical disks, hard disks or any other machine-readable (ex, computer-readable) storage media, or not limited to the computer program products of external forms. When the code is loaded into and executed by a machine, the machine becomes the device participating in the present invention. The code could be transmitted through some transmitting media such as power wires or power cables, optical cables or media of any transmission type. When the code is received, loaded and performed by the machine (ex, a computer), the machine becomes the device participating in the present invention. When it is performed by a general processing unit, the code combined with the processing unit provides the operation, which is similar to the specific device applying specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method, utilized for re-initiating a computer system, wherein the computer system comprises a control unit and a storage unit, and the storage unit comprises a first storage block and a second storage block to respectively store a first initiating code and a second initiating code, the first storage block being different from the second storage block, and the control method comprising:
determining by the control unit whether the computer system is normally initiated or not;
the computer system entering a normal operation mode when the control unit determines that the computer system is normally initiated;
the computer system entering an emergency back-up mode when the control unit determines that the computer system is not normally initiated; and
reading the second initiating code of the second storage block by the control unit for re-initiating the computer system when the computer system enters the emergency back-up mode.

2. The control method as claimed in claim 1, wherein when the computer system enters the emergency back-up mode, the first initiating code in the first storage block is not repaired or updated, and the second initiating code at the second storage block is directly read by the control unit.

3. The control method as claimed in claim 1, wherein the second initiating code comprises indication information about re-initiating the computer system, and the control method further comprises displaying the indication information on a display unit of the computer system by the control unit.

4. The control method as claimed in claim 1, further comprising forbidding reading or writing of the second initiating code in the second storage block when the computer system enters the normal operation mode.

5. The control method as claimed in claim 1, wherein the step of determining whether the computer system is normally initiated comprises determining by the control unit that the computer system cannot be normally initiated by the control unit when the control unit does not receive the first initiating code from the storage unit within a predetermined time.

6. The control method as claimed in claim 1, wherein the step of determining whether the computer system is normally initiated comprises determining by the control unit that the computer system cannot be normally initiated by the control unit when the control unit receives the first initiating code from the storage unit within a predetermined time but does not receive an operating system (OS) code from the storage unit to re-initiate an OS of the computer system.

7. The control method as claimed in claim 1, wherein the step of re-initiating the computer system further comprises driving a chip unit to reset the computer system by the control unit, and reading the second initiating code of the second storage block by the control unit to re-initiate the computer system.

8. A computer system, comprising:
a storage unit, comprising a first storage block and a second storage block to respectively store a first initiating code and a second initiating code, wherein the first storage block is different from the second storage block; and
a control unit, utilized to determine whether the computer system is normally initiated or not, wherein the computer system enters a normal operation mode when the control unit determines that the computer system is normally initiated, and the computer system enters an emergency back-up mode and the control unit reads the second initiating code of the second storage block for re-initiating the computer system when the control unit determines that the computer system is not normally initiated.

9. The computer system as claimed in claim 8, wherein when the computer system enters the emergency back-up mode, the control unit does not repair or update the first initiating code at the first storage block but directly reads the second initiating code at the second storage block.

10. The computer system as claimed in claim 8, wherein the second initiating code comprises indication information about re-initiating the computer system, and the control unit displays the indication information on a display unit of the computer system.

11. The computer system as claimed in claim 8, wherein the second initiating code in the second storage block is forbidden from being read or written to when the computer system enters the normal operation mode.

12. The computer system as claimed in claim 8, wherein the control unit determines that the computer system cannot be initiated normally when the control unit does not receive the first initiating code from the storage unit within a predetermined time.

13. The computer system as claimed in claim 8, wherein the control unit determines that the computer system cannot be normally initiated when the control unit receives the first initiating code from the storage unit within a predetermined time but does not receive an operating system (OS) code from the storage unit to re-initiate an OS of the computer system.

14. The computer system as claimed in claim 8, wherein the control unit drives a chip unit to reset the computer system by the control unit, and reads the second initiating code of the second storage block by the control unit to re-initiate the computer system.
